(19) United States
(12) Patent Application Publication
(10) Pub. No.: US 2024/0140011 A1
(43) Pub. Date: May 2, 2024

(54) INFORMATION PROCESSING DEVICE, INJECTION MOLDING MACHINE, AND NON-TRANSITORY COMPUTER READABLE MEDIUM STORING PROGRAM

(71) Applicant: SUMITOMO HEAVY INDUSTRIES, LTD., Tokyo (JP)

(72) Inventor: Masanobu NAKAZONO, Yokosuka-shi (JP)

(21) Appl. No.: 18/465,718

(22) Filed: Sep. 12, 2023

(30) Foreign Application Priority Data
Oct. 26, 2022 (JP) 2022-171659

(51) Int. Cl. B29C 45/76

(52) U.S. Cl. CPC B29C 45/768; B29C 2045/7606

(57) ABSTRACT

An information processing device receives an operation of setting an adjustment condition for an automatic adjustment function in an injection molding machine capable of automatically adjusting a molding condition, and the information processing device includes: a first input reception unit that receives an input of a quality item related to maintaining a quality of a molding product as the setting of the adjustment condition; and a second input reception unit that receives an input of an adjustment item as an adjustment target for maintaining the quality of the molding product as the setting of the adjustment condition.

### CROSS-REFERENCE TO RELATED APPLICATIONS

This application claims priority to Japanese Patent Application No. 2022-171659, filed on Oct. 26, 2022, which is incorporated by reference herein in its entirety.

### BACKGROUND

### Technical Field

A certain embodiment of the present invention relates to an information processing device, an injection molding machine, and a non-transitory computer readable medium storing a program.

### Description of Related Art

The related art discloses a molding condition determination supporting device that includes a molding-time state data adjustment amount acquisition unit that acquires a molding-time state data adjustment amount, which is a value corresponding to a difference between molding-time state data detected by a sensor and a molding-time state data target value, using a first learning model, and a molding condition element adjustment amount acquisition unit that acquires an adjustment amount of a molding condition element corresponding to the molding-time state data adjustment amount using a second learning model, and adjusts the molding condition element based on the acquired adjustment amount.

The related art discloses a molding optimization method in which molding data during a molding process as constraint conditions and evaluation information related to a molding quality, a prediction function based on learning of a neural network as an objective function, and an optimization processing program for obtaining optimized molding conditions related to input parameters that satisfy the constraint conditions and the objective function are set for molding data related to input parameters and output parameters in a data processing unit, molding data related to output parameters during the molding process is detected by the data processing unit during production operation, molding conditions optimized by the optimization processing program are obtained based on molding data related to the output parameters, and existing molding conditions are changed according to the obtained molding conditions.

### SUMMARY

According to an embodiment of the present invention, there is provided an information processing device that receives an operation of setting an adjustment condition for an automatic adjustment function in an injection molding machine capable of automatically adjusting a molding condition, the information processing device including: a first input reception unit that receives an input of a quality item related to maintaining a quality of a molding product as the setting of the adjustment condition; and a second input reception unit that receives an input of an adjustment item as an adjustment target for maintaining the quality of the molding product as the setting of the adjustment condition.

### BRIEF DESCRIPTION OF THE DRAWINGS

FIG. 1 is a diagram illustrating a configuration of an injection molding machine to which the present embodiment is applied.

FIG. 2 is a diagram illustrating a configuration of a control device.

FIG. 3 is a diagram illustrating a configuration of a data processing device.

FIG. 4 is a diagram illustrating a hardware configuration example of the control device and the data processing device.

FIG. 5 is a diagram illustrating a configuration example of an operation screen for setting adjustment conditions.

FIG. 6 is a diagram illustrating an example of a data file of adjustment conditions.

FIG. 7 is a flowchart illustrating an operation of monitoring adjustment of a molding condition by a monitoring unit.

FIG. 8 is a diagram illustrating a configuration example of an operation screen for setting detailed adjustment information.

### DETAILED DESCRIPTION

In order to use the function of automatically adjusting the molding condition, it is necessary to set an adjustment condition for performing desired adjustment. The content of setting such an adjustment condition varies depending on the types of molds or molding machines or the like. Therefore, as means for receiving an operation of setting the adjustment condition by a user, a highly convenient user interface capable of responding to various situations is required.

It is desirable to provide a user interface capable of receiving an operation by a user and setting adjustment conditions in response to various situations.

Hereinafter, an embodiment of the present invention will be described in detail with reference to the accompanying drawings.

### Device Configuration

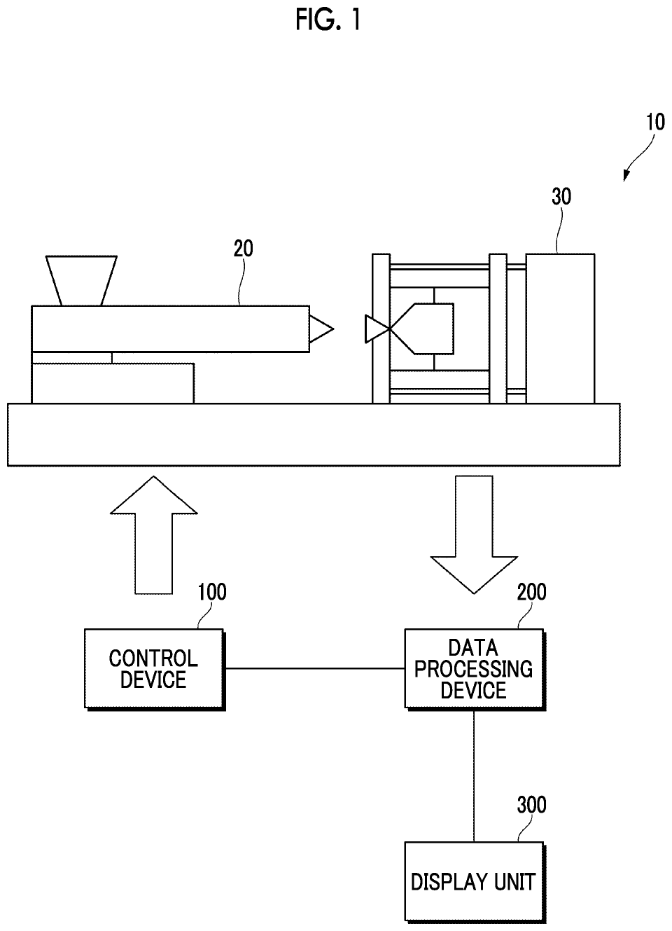

FIG. 1 is a diagram illustrating a configuration of an injection molding machine to which the present embodiment is applied. An injection molding machine 10 includes an injection unit 20, a mold clamping unit 30, a control device 100, a data processing device 200, and a display unit 300. In the following description, a direction from the injection unit 20 toward the mold clamping unit 30 may be referred to as forward.

The injection unit 20 includes a cylinder that heats a molding material, a screw that is rotatable in the cylinder and that is provided to be able to advance and retreat in an axial direction, a rotary motor that drives the screw in a rotational direction, a motor that drives the screw in the axial direction, and the like. The molding material is, for example, a resin or the like. The injection unit 20 injects the molding material heated and liquefied within the cylinder by advancing the screw forward while rotating the screw, and fills a mold of the mold clamping unit 30 disposed in front of the injection unit 20 with the molding material. The injection unit 20 performs, for example, a plasticizing process, a filling process, a holding pressure process, and the like in a manufacturing process of a molding product. The filling process and the holding pressure process may be collectively referred to as an injection process.

The mold clamping unit 30 includes a mold, a tightening mechanism for tightening the mold, a motor for driving the tightening mechanism, and the like. The mold clamping unit 30 closes the mold and receives the molding material injected from the injection unit 20 into the inside of the mold. In this case, the mold clamping unit 30 tightens the mold with the tightening mechanism such that the mold does not open because of the filling of the molding material (mold clamping). A molding product is produced by solidifying the molding material filled in the mold. After that, the mold clamping unit 30 opens the mold and feeds out the produced molding product. The mold clamping unit 30 performs, for example, a mold closing process, a pressurizing process, a mold clamping process, a depressurizing process, a mold opening process, and the like in a manufacturing process of a molding product.

The control device 100 is a device that controls the operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation of inputting commands or data to the control device 100 or the data processing device 200.

### Configuration of Control Device 100

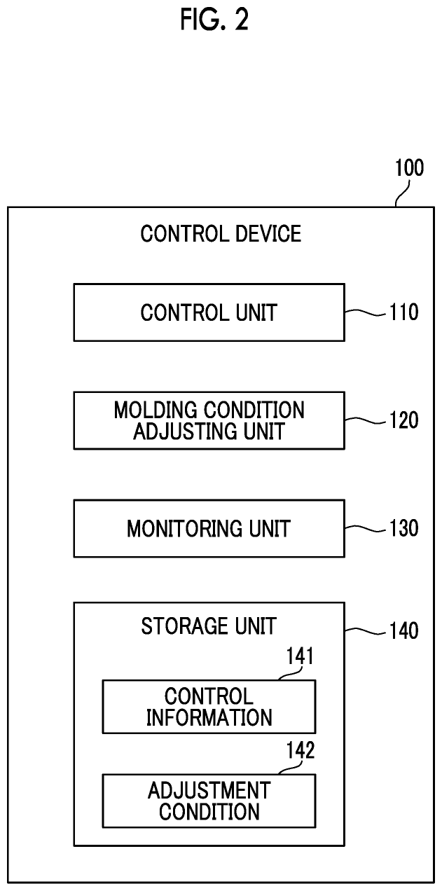

FIG. 2 is a diagram illustrating a configuration of the control device 100. The control device 100 controls the operations of the injection unit 20 and the mold clamping unit 30. For example, the control device 100 is implemented by a computer. The control device 100 includes a control unit 110, a molding condition adjusting unit 120, a monitoring unit 130, and a storage unit 140. The control device 100 controls the injection unit 20 and the mold clamping unit 30 to repeatedly perform processes related to the manufacture of a molding product, thereby repeatedly manufacturing the molding product. Processes related to the manufacture of a molding product include a plasticizing process, a mold closing process, a pressurizing process, a mold clamping process, a filling process, a holding pressure process, a cooling process, a depressurizing process, a mold opening process, an ejecting process, and the like. Hereinafter, these processes related to the manufacture may be collectively referred to as a “manufacturing process”. A series of operations for obtaining the molding product, for example, an operation from the start of the plasticizing process in the manufacturing process to the start of the next plasticizing process, is referred to as a “shot”, a “molding cycle”, or the like. Further, each of the above-described processes for manufacturing a molding product is merely an example. For example, the process executed in one shot may include other processes not included in the above processes.

The control unit 110 controls the injection unit 20 and the mold clamping unit 30 based on the control information. The control information is a condition set by a user, and is input by the user using, for example, an input unit (not illustrated). The control information includes, for example, molding conditions such as a resin temperature, a mold temperature (cylinder temperature), an injection holding pressure time, a plasticizing value, a V-P switching position, a holding pressure, an injection speed (filling speed), a screw rotation speed, a screw back pressure, and a mold clamping force. A plurality of combinations of these molding conditions are determined according to the molding product and the mold. This combination data of the molding conditions will be hereinafter referred to as a molding condition data set. The control unit 110 stores the acquired control information in the storage unit 140 as a molding condition data set.

The control unit 110 controls the injection unit 20 and the mold clamping unit 30 using the above-described molding condition data set, and performs processes related to the manufacture (shot) of a molding product including each of the above-described processes. The control unit 110 reads the molding condition data set corresponding to the molding product to be manufactured from the storage unit 140 at the time of starting the manufacturing of the molding product or the like. Then, the control unit 110 controls the operations of the injection unit 20 and the mold clamping unit 30 based on the read control information. Specifically, the control unit 110 controls the injection unit 20 and the mold clamping unit 30 such that the data obtained from the injection unit 20 and the mold clamping unit 30 in the manufacturing process match the setting values of the molding condition data set. In addition, the control unit 110 may cause the display unit 300 to display the molding condition data set read from the storage unit 140. The user may refer to the data of the molding condition displayed on the display unit 300 and perform an operation such as correction of the value as necessary.

The molding condition adjusting unit 120 adjusts the molding condition used in the control of the injection unit 20 and the mold clamping unit 30 by the control unit 110. When the manufacturing process of the molding product is repeated, the states of the injection unit 20 and the mold clamping unit 30 change, and the changes in the states of the units 20 and 30 affect the quality of the molding product. Therefore, in order to maintain the quality of the molding product in an operation when the molding product is mass-produced (hereinafter referred to as an “operation during mass production”), the molding condition adjusting unit 120 automatically adjusts the molding condition. The molding condition adjusting unit 120 adjusts the molding condition in accordance with the changes in the states of the injection unit 20 and the mold clamping unit 30 at the time of mass production by using machine learning or another mathematical optimization method. As the mathematical optimization method used by the molding condition adjusting unit 120, various existing methods can be used. For example, the molding condition adjusting unit 120 inputs data acquired by a data acquisition unit 210 of the data processing device 200, which will be described later, outputs optimized control information, and adjusts control conditions of the injection unit 20 and the mold clamping unit 30 by the control unit 110.

The monitoring unit 130 monitors the adjustment content of the molding condition by the molding condition adjusting unit 120, and determines whether or not the adjustment content satisfies a predetermined condition. Specifically, the monitoring unit 130 determines whether or not the adjustment content of the molding condition by the molding condition adjusting unit 120 deviates from an adjustment condition set by an adjustment condition setting unit 230 of the data processing device 200, which will be described later. Then, when the adjustment content deviates from the adjustment condition, the monitoring unit 130 notifies the control unit 110 to stop the operations of the injection unit 20 and the mold clamping unit 30, for example. In addition, the monitoring unit 130 determines whether or not the molding condition adjusted by the molding condition adjusting unit 120 exceeds a threshold determined based on the above-mentioned adjustment condition. Then, when the adjusted molding condition exceeds the threshold, the monitoring unit 130 issues an alarm (alert) to the user of the injection molding machine 10, for example.

The storage unit 140 holds control information 141 used for controlling the injection unit 20 and the mold clamping unit 30. The molding condition data set included in the control information 141 is prepared in association with the molding product or the mold to be manufactured. The storage unit 140 holds a molding condition data set for each molding product or mold to be manufactured. In addition, the storage unit 140 holds an adjustment condition 142 used for monitoring the adjustment content of the molding condition by the monitoring unit 130. The adjustment condition 142 is set by the adjustment condition setting unit 230 of the data processing device 200, is sent from the data processing device 200 to the control device 100, and is stored in the storage unit 140.

Further, although not illustrated, the storage unit 140 holds a program for the control unit 110 to control the injection unit 20 and the mold clamping unit 30, a program for the molding condition adjusting unit 120 to adjust the molding condition, and a program for the monitoring unit 130 to monitor the adjustment content of the molding condition by the molding condition adjusting unit 120. As will be described in detail later, the functions of the control unit 110, the molding condition adjusting unit 120, and the monitoring unit 130 are implemented by a processor reading and executing the program held in the storage unit 140 in the control device 100.

### Configuration of Data Processing Device

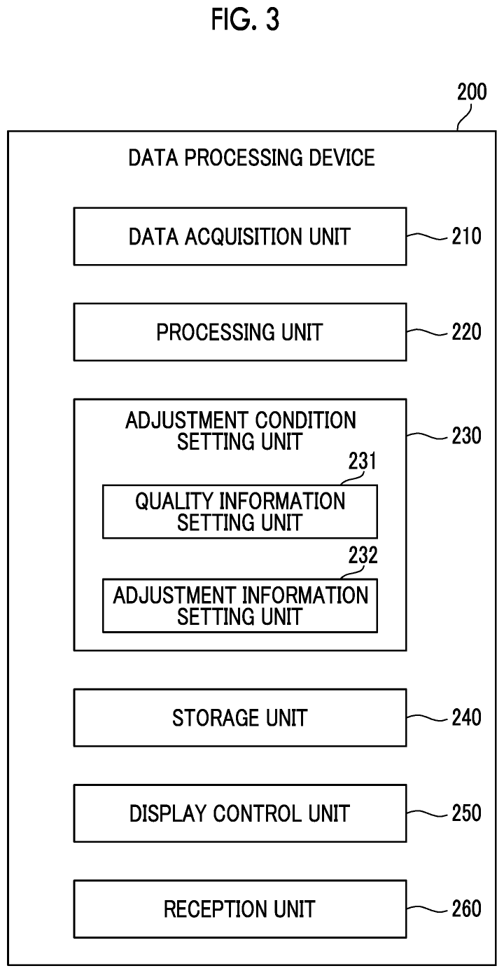

FIG. 3 is a diagram illustrating a configuration of the data processing device 200. The data processing device 200 acquires and processes data obtained as the injection unit 20 and the mold clamping unit 30 execute the operations in the process related to the manufacture of the molding product. In addition, the data processing device 200 receives a setting operation by the user, and sets an adjustment condition for the molding condition of the manufacturing process by the control unit 110 of the control device 100. The data processing device 200 is implemented by, for example, a computer. The data processing device 200 includes the data acquisition unit 210, a processing unit 220, the adjustment condition setting unit 230, a storage unit 240, a display control unit 250, and a reception unit 260.

The data acquisition unit 210 acquires data to be processed from the injection unit 20 and the mold clamping unit 30. Various sensors and detectors are attached to the injection unit 20 and the mold clamping unit 30. In some cases, a measuring device is connected to the injection molding device. The data acquired by these sensors, detectors, and measuring devices (hereinafter referred to as “acquired data”) is information indicating a molding result by the injection unit 20 and the mold clamping unit 30, and is used for quality control of a molding product. Specifically, for example, a weight of the molding product, dimensions of the molding product, a mold internal pressure, a minimum cushion position, a characteristic amount of a waveform of a filling pressure, and the like are included. These pieces of acquired data are actual values obtained in the manufacturing process of the molding product. The data acquisition unit 210 receives acquired data transmitted from the sensors, the detectors, or the measuring devices, and stores the acquired data in the storage unit 240.

The processing unit 220 processes the acquired data stored in the storage unit 240. Specifically, the processing unit 220 performs a process of extracting a representative value of the acquired data in each process, generating time-series data in which the acquired data in each process is time-series, and the like. In the extraction of the representative value, the processing unit 220 performs statistical processing on the acquired data, such as calculation of an average value, specification of a range of possible values, and specification of a maximum value and a minimum value.

The adjustment condition setting unit 230 sets an adjustment condition applied to an automatic adjustment function of the molding condition in the control device 100. As described with reference to FIG. 2, the control device 100 includes the molding condition adjusting unit 120, and the molding condition adjusting unit 120 adjusts the molding condition used in the control of the injection unit 20 and the mold clamping unit 30 by the control unit 110. The adjustment condition setting unit 230 sets adjustment conditions in the adjustment of the molding condition by the molding condition adjusting unit 120. The adjustment conditions include information related to maintenance of the quality of the molding product (hereinafter referred to as “quality information”) and information specifying the adjustment content for maintaining the quality of the molding product (hereinafter referred to as “adjustment information”). For example, the quality information corresponds to acquired data acquired by the data acquisition unit 210. For example, the adjustment information corresponds to control information used when the control unit 110 of the control device 100 controls the injection unit 20 and the mold clamping unit 30.

The adjustment condition setting unit 230 includes a quality information setting unit 231 that receives the setting of the quality information and an adjustment information setting unit 232 that receives the setting of the adjustment information. As the quality information, the quality information setting unit 231 sets an adjustment condition for an item representing the quality of the molding product (hereinafter referred to as a “quality item”) among the molding conditions related to the manufacture of the molding product. For example, this adjustment condition is set as a range of adjustment values for each quality item. As the adjustment information, the adjustment information setting unit 232 sets an adjustment condition for an item to be adjusted in order to maintain the quality of the molding product (hereinafter referred to as an “adjustment item”) among the molding conditions related to the manufacture of the molding product. For example, this adjustment condition is set as a range of control values for each item. The setting of these adjustment conditions is performed by receiving a user setting operation for an operation screen, which will be described later, creating a data file of the adjustment condition 142 stored in the storage unit 140 described with reference to FIG. 2, and sending the created data file from the data processing device 200 to the control device 100. Details of the operation screen and the setting operation will be described later.

The storage unit 240 holds the acquired data acquired by the data acquisition unit 210 and a data file of the adjustment condition created by the adjustment condition setting unit 230. For example, binary, text, comma-separated values (CSV), INI, YAML Ain't Markup Language (YAML), JavaScript Object Notation (JSON), or the like can be used as the data format of the data file of the adjustment condition. By using these general-purpose data formats as data files, it is possible to exchange data in data files of adjustment conditions with those in other information processing devices, and to edit data files of adjustment conditions acquired from an external device.

Further, although not illustrated, the storage unit 240 holds a program for the processing unit 220 to execute data processing, a program for the adjustment condition setting unit 230 to create a data file of adjustment conditions, a program for causing the display control unit 250 to display a screen on the display unit 300, and a program for the reception unit 260 to receive a user's operation performed on the operation screen. As will be described in detail later, the functions of the processing unit 220, the adjustment condition setting unit 230, the display control unit 250, and the reception unit 260 are implemented by the processor reading and executing the program held in the storage unit 240 in the data processing device 200.

The display control unit 250 generates an operation screen for the adjustment condition setting unit 230 to set the adjustment condition, and causes the display unit 300 to display the operation screen. As will be described in detail later, the operation screen for setting the adjustment condition is provided with an input unit for inputting quality information and an input unit for inputting adjustment information.

The reception unit 260 receives an operation performed by the user on the operation screen displayed on the display unit 300. Specifically, for example, the reception unit 260 receives data input performed in an input field of the operation screen, a screen switching operation, or the like. The operation screen displayed on the display unit 300 by the display control unit 250, the reception unit 260, and the quality information setting unit 231 of the adjustment condition setting unit 230 are examples of a first input reception unit. The operation screen displayed on the display unit 300 by the display control unit 250, the reception unit 260, and the adjustment information setting unit 232 of the adjustment condition setting unit 230 are examples of a second input reception unit. In addition to the input performed by the operation performed via the operation screen, the reception unit 260 may read and receive a data file of adjustment conditions stored in a storage medium, or may receive a data file of adjustment conditions received from an external device via a network.

### Hardware Configuration of Control Device and Data Processing Device

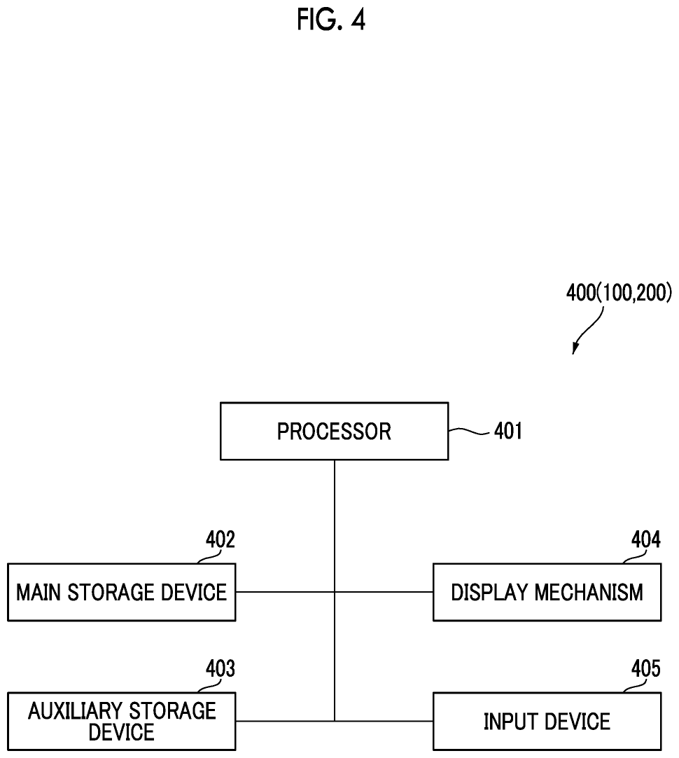

FIG. 4 is a diagram illustrating a hardware configuration example of a computer 400 that implements the control device 100 and the data processing device 200. The computer illustrated in FIG. 4 includes a processor 401 as calculation means, and a main storage device (main memory) 402 and an auxiliary storage device 403 as storage means. As the processor 401, for example, various arithmetic circuits such as a central processing unit (CPU), a graphics processing unit (GPU), an application-specific integrated circuit (ASIC), and a field-programmable gate array (FPGA) can be used. The processor 401 reads a program stored in the auxiliary storage device 403 into the main storage device 402 and executes the program. As the main storage device 402, for example, a random-access memory (RAM) is used. As the auxiliary storage device 403, for example, a magnetic disk device, a solid-state drive (SSD), or the like is used. The computer also includes a display mechanism 404 for outputting a display on the display unit (display) 300, and an input device 405 on which an input operation is performed by a user of the computer. For example, a keyboard, a mouse, or the like is used as the input device 405. The configuration of the computer illustrated in FIG. 4 is merely an example, and the computer used in the present embodiment is not limited to the configuration example illustrated in FIG. 4. For example, a configuration including a non-volatile memory such as a flash memory or a read-only memory (ROM) as a storage device may be used.

When the control device 100 is implemented by the computer illustrated in FIG. 4, the functions of the control unit 110, the molding condition adjusting unit 120, and the monitoring unit 130 are implemented by, for example, the processor 401 reading and executing the program. The storage unit 140 is implemented by, for example, the auxiliary storage device 403.

When the data processing device 200 is implemented by the computer illustrated in FIG. 4, the functions of the data acquisition unit 210, the processing unit 220, and the adjustment condition setting unit 230 are implemented by, for example, the processor 401 reading and executing the program. The storage unit 240 is implemented by, for example, the auxiliary storage device 403. The display control unit 250 is implemented by, for example, the processor 401 and the display mechanism 404 that read and execute the program. The reception unit 260 is implemented by, for example, the processor 401 and the input device 405 that read and execute the program.

### Operation Screen

### Configuration Example

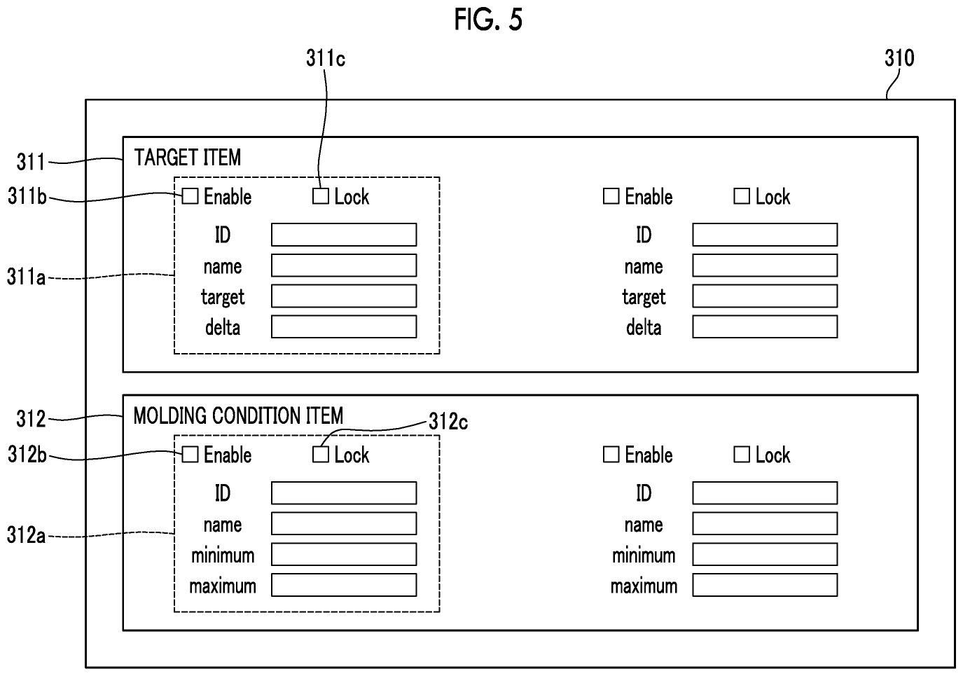

FIG. 5 is a diagram illustrating a configuration example of an operation screen for setting adjustment conditions. The display control unit 250 of the data processing device 200 generates an operation screen 310 as illustrated in FIG. 5, and displays the operation screen 310 on the display unit 300. For example, the user inputs the setting information of the adjustment condition to the operation screen 310 using the input device 405 described with reference to FIG. 4. The reception unit 260 of the data processing device 200 receives setting information input on the operation screen. The adjustment condition setting unit 230 of the data processing device 200 creates a data file of the adjustment condition based on the setting information received by the reception unit 260, and transmits the data file to the control device 100.

The operation screen 310 illustrated in FIG. 5 is provided with a quality information input unit 311 for inputting quality information and an adjustment information input unit 312 for inputting adjustment information. The quality information input unit 311 displays at least one single quality information input unit 311a. The single quality information input unit 311a is an input unit for inputting quality information related to one quality item, and is an example of a first input unit. In addition, the adjustment information input unit 312 displays at least one single adjustment information input unit 312a. The single adjustment information input unit 312a is an input unit for inputting adjustment information related to one adjustment item, and is an example of a second input unit.

In the example illustrated in FIG. 5, two single quality information input units 311a are displayed on the quality information input unit 311, and two single adjustment information input units 312a are displayed on the adjustment information input unit 312. For example, the number of the single quality information input units 311a and the single adjustment information input units 312a displayed on the quality information input unit 311 and the adjustment information input unit 312 may be controlled by the display control unit 250 of the data processing device 200 according to the size of the display screen of the display unit 300. For example, when the operation screen 310 is displayed on the display unit 300 having a large screen, three or more single quality information input units 311a and single adjustment information input units 312a may be displayed, or when the operation screen is displayed on the display unit 300 having a small screen such as a smartphone, one single quality information input unit 311a and one single adjustment information input unit 312a may be displayed one by one. Further, the number of the single quality information input units 311a and the single adjustment information input units 312a displayed on the operation screen 310 may be set by a manual operation of the user. When the number of items of quality information and adjustment information to be input is greater than the number of the single quality information input units 311a and the single adjustment information input units 312a displayed on the operation screen 310, the operation screen 310 may be configured to enable input by scrolling the screen or switching display.

On the operation screen 310 illustrated in FIG. 5, the single quality information input unit 311a includes an input field for information specifying a quality item and an input field for a possible range of adjustment values for the quality item. In the illustrated example, an input field for information specifying a quality item is configured to input identification information (denoted as “ID” in the drawing) and an item name (denoted as “name” in the drawing). Here, since the identification information and the item name are both information specifying the quality item, when the user inputs any one of the identification information and the item name, the other may be automatically input. In addition, the input may be validated when the quality items specified by each of the identification information and the item name input by the user match. In this case, when quality items do not match, a warning message or the like may be configured to be output. Further, as the input operation, in addition to the method of inputting characters in the input field as illustrated, a method of inputting by selecting from a drop-down or a list on another screen (pop-out) may be used.

The input field for the possible range of the adjustment value for the quality item is configured to enable input of a target value (denoted as “target” in the drawing) and of an allowable range value (denoted as “delta” in the drawing). Here, the allowable range value is indicated by the amount of deviation that is allowed with respect to the target value. For example, for a certain quality item, when the input of the target value is 6 mm and the input of the allowable range value is 1 mm, 5 mm to 7 mm(=6 mm±1 mm) is a possible range of the adjustment value for this quality item.

Further, on the operation screen 310 illustrated in FIG. 5, the single adjustment information input unit 312a includes an input field for information specifying an adjustment item and an input field for a possible range of control values for the adjustment item. In the illustrated example, an input field for information specifying an adjustment item is configured to enable input of identification information (denoted as “ID” in the drawing) and of an item name (denoted as “name” in the drawing). The input field for the possible range of the control value for the adjustment item is configured to enable input of a minimum value (denoted as “minimum” in the drawing) and of a maximum value (denoted as “maximum” in the drawing).

In the following description, inputting the identification information and the item name in the input field for the information specifying the quality item in the single quality information input unit 311a may be referred to as “setting the quality item” or “setting the item”. In addition, inputting the target value and the allowable range value into the input field for the possible range of the adjustment value for the quality item in the single quality information input unit 311a may be referred to as “setting the adjustment value”. In addition, inputting the identification information and the item name in the input field for the information specifying the adjustment item in the single adjustment information input unit 312a may be referred to as “setting the adjustment item” or “setting the item”. In addition, inputting the minimum value and the maximum value into the input field for the possible range of the control value for the adjustment item in the single adjustment information input unit 312a may be referred to as “setting the control value”.

On the operation screen 310 displayed on the display unit 300, the user inputs the identification information and the item name as the information specifying the quality item for which the adjustment condition is to be set in the single quality information input unit 311a, and inputs the target value and the allowable range for the specified quality item. In addition, the identification information, the item name, the minimum value, and the maximum value of the adjustment item for which the adjustment condition is to be set are input to the single adjustment information input unit 312a. In the data processing device 200, the reception unit 260 receives the data input on the operation screen 310, and the adjustment condition setting unit 230 creates a data file of the adjustment condition using the data received by the reception unit 260.

On the operation screen 310 illustrated in FIG. 5, each single quality information input unit 311a and each single adjustment information input unit 312a are each provided with two check boxes. A check box 311b marked with “Enable” provided in the single quality information input unit 311a is a check box for setting whether or not to validate the quality information input to the single quality information input unit 311a. A check box 312b marked with “Enable” provided in the single adjustment information input unit 312a is a check box for setting whether or not to validate the adjustment information input to the single adjustment information input unit 312a. The check boxes 311b and 312b are examples of a valid setting unit.

Validating the quality information input to the single quality information input unit 311a means that the molding condition adjusting unit 120 of the control device 100 adjusts the molding condition based on the input quality information. More specifically, it means that the adjustment of the molding condition performed by the molding condition adjusting unit 120 is controlled by the monitoring unit 130 so as not to exceed a possible range of the adjustment value set by the quality information input to the single quality information input unit 311a. When the check box 311b is checked, the quality information input to the single quality information input unit 311a becomes valid, and the control device 100 adjusts the molding condition using the quality information as the adjustment condition. On the other hand, when the check box 311b is not checked, the quality information input to the single quality information input unit 311a becomes invalid, and the control device 100 does not adjust the molding condition using the quality information as the adjustment condition.

Similarly, validating the adjustment information input to the single adjustment information input unit 312a means that the molding condition adjusting unit 120 of the control device 100 adjusts the molding condition based on the input adjustment information. More specifically, it means that the adjustment of the molding condition performed by the molding condition adjusting unit 120 is controlled by the monitoring unit 130 so as not to exceed a possible range of the control value set by the adjustment information input to the single adjustment information input unit 312a. When the check box 312b is checked, the adjustment information input to the single adjustment information input unit 312a becomes valid, and the control device 100 adjusts the molding condition using the adjustment information as the adjustment condition. On the other hand, when the check box 312b is not checked, the adjustment information input to the single adjustment information input unit 312a becomes invalid, and the control device 100 does not adjust the molding condition using the adjustment information as the adjustment condition.

A check box 311c marked with “Lock” provided in the single quality information input unit 311a is a check box for setting whether or not the quality information input to the single quality information input unit 311a can be changed. A check box 312c marked with “Lock” provided in the single adjustment information input unit 312a is a check box for setting whether or not the adjustment information input to the single adjustment information input unit 312a can be changed. The check boxes 311c and 312c are examples of an input fixing unit.

When the check box 311c is checked, the user cannot change the input quality information by performing a re-input operation on the single quality information input unit 311a. On the other hand, when the check box 311c is not checked, the user can change the input quality information by performing a re-input operation on the single quality information input unit 311a. Similarly, when the check box 312c is checked, the user cannot change the input adjustment information by performing a re-input operation on the single adjustment information input unit 312a. On the other hand, when the check box 312c is not checked, the user can change the input adjustment information by performing a re-input operation on the single adjustment information input unit 312a.

### Display of Recommended Adjustment Item and Recommended Control Value

There is a case where an item set in the single quality information input unit 311a and an item set in the single adjustment information input unit 312a are related to each other. Therefore, when a quality item is set, an adjustment item to be set (hereinafter referred to as a “recommended adjustment item”) is often determined based on general knowledge. Therefore, when a quality item is set in the single quality information input unit 311a, a recommended adjustment item specified according to the set quality item may be displayed in an input field for information specifying the adjustment item in the single adjustment information input unit 312a.

For example, the minimum cushion position, which is one piece of information regarding the quality of the molding product, is affected by the holding pressure, which is the control information used by the control unit 110 of the control device 100 to control the injection unit 20 and the mold clamping unit 30. Therefore, when the minimum cushion position is input as the quality item of the single quality information input unit 311a, the holding pressure is displayed as a recommended adjustment item in one single adjustment information input unit 312a of the adjustment information input unit 312.

In addition, a mold internal pressure peak value, which is information related to the quality of the molding product, is affected by the holding pressure and the V-P switching position, which are control information. Therefore, when the mold internal pressure peak value is input as the quality item of the single quality information input unit 311a, the holding pressure is displayed as a recommended adjustment item in one single adjustment information input unit 312a of the adjustment information input unit 312, and the V-P switching position is displayed as a recommended adjustment item in the other single adjustment information input unit 312a.

In addition, a nozzle portion pressure peak value, which is information related to the quality of the molding product, is affected by the injection speed and the V-P switching position, which are control information. Therefore, when the nozzle portion pressure peak value is input as the quality item of the single quality information input unit 311a, the injection speed is displayed as a recommended adjustment item in one single adjustment information input unit 312a of the adjustment information input unit 312, and the V-P switching position is displayed as a recommended adjustment item in the other single adjustment information input unit 312a.

When the adjustment value of the quality item is set between the related quality item and adjustment item as described above, the range of the control value of the related adjustment item may be generally specified (hereinafter, this range of the control value is referred to as a “recommended control value”). The recommended control value can be specified based on past actual molding results or information prepared in advance by an injection molding machine manufacturer, an end user, or the like. The actual molding results and information may be stored in the storage unit 240 of the data processing device 200, or may be received and acquired from an external device via a network. When the recommended control value is specified according to the setting of the adjustment value, in a case where the adjustment value of the quality item is set in the single quality information input unit 311a, in the single adjustment information input unit 312a in which the recommended adjustment item is displayed, the recommended control value specified according to the set adjustment value may be displayed in the input field for the possible range of the control value of the single adjustment information input unit 312a. The recommended control value is an example of a reference value.

Information on the relationship between the quality item and the recommended adjustment item and the relationship between the adjustment value set in the quality item and the recommended control value described above is held in the storage unit 240 of the data processing device 200, for example. The display control unit 250 searches the storage unit 240 when a quality item or an adjustment value thereof is set on the operation screen 310. Then, when there is information on the recommended adjustment item or the recommended control value corresponding to the set quality item and adjustment value, the display control unit 250 acquires the corresponding information and causes the single adjustment information input unit 312a of the operation screen 310 to display the information. Information on the recommended control value may be prepared in advance and stored in the storage unit 240, or may be generated by the processing of the processing unit 220 based on the acquired data acquired by the data acquisition unit 210 of the data processing device 200 and stored in the storage unit 240.

Regarding the relationship between the adjustment value and the recommended control value, it is not practical to specify recommended control values corresponding to all the adjustment values that can be input and hold the recommended control values in the storage unit 240. Therefore, when information on the relationship between the adjustment value and the recommended control value for some specific adjustment values is held in the storage unit 240, and the difference between an input adjustment value A and one adjustment value B in the information held in the storage unit 240 is within a predetermined range, the display control unit 250 may apply the information about the adjustment value B held in the storage unit 240 as information on the recommended control value corresponding to the input adjustment value A, and display the obtained recommended control value on the single adjustment information input unit 312a of the operation screen 310. Further, the display control unit 250 may calculate a recommended control value for the adjustment value A input based on a predetermined calculation formula according to the difference between the adjustment value A and the adjustment value B, and display the recommended control value on the single adjustment information input unit 312a of the operation screen 310.

Moreover, a setting may be made to allow a range in calculating the recommended control value. For example, as a combination of the recommended control value and the adjustment value (the recommended control value and the adjustment value) held in the storage unit 240, a case is considered where there are sets (1, 10), (3, 30), (5, 50), and so on, and it is known that they are correlated. When the data such as the actual molding results used for calculating the recommended control value is insufficient and the support for the data is not certain, an operation such as displaying the recommended control value having a wide range of, for example, about ±50%, is performed, and when the data is abundant and the support for the data is certain, an operation such as displaying a recommended control value having a range of, for example, about ±0 to 10%, is performed. For example, as a specific value, when the range of the adjustment value is 20 to 30, in a case where the support for the data such as the actual molding results is certain, a value of 2 (a value obtained by subtracting 0% of “2” from “2”) to 3 (a value obtained by adding 0% of “3” to “3”) as a recommended control value may be displayed in the single adjustment information input unit 312a, and in a case where the support for the data is not certain, a value of 1 (a value obtained by subtracting 50% of “2” from “2”) to 4.5 (a value obtained by adding 50% of “3” to “3”) as a recommended control value may be displayed in the single adjustment information input unit 312a.

In addition, when the set adjustment value is a value close to the adjustment value in a set of the recommended control value and the adjustment value held in the storage unit 240, the range of the recommended control values may be decreased, and when the set adjustment value is a value far from the adjustment value in the set of the recommended control value and the adjustment value held in the storage unit 240, the range of the recommended control values may be increased. As specific values, a case is considered where sets of the recommended control value and the adjustment value held in the storage unit 240 are (1, 10), (3, 30), (5, 50), and so on, and the adjustment values are increments of 20, such as 10, 30, 50, and so on. Here, when the set range of the adjustment value is 10 to 30, since the minimum value 10 and the maximum value 30 in this range are held in the storage unit 240, the recommended control value is also set to 1 to 3 with high accuracy. Therefore, the values of 1 to 3 are displayed on the single adjustment information input unit 312a, with the range of the recommended control values being 0%. On the other hand, when the set range of adjustment value is 15 to 20, the minimum value 15 and the maximum value 20 in this range are between the adjustment values 10 and 30 held in the storage unit 240, and are values farther from the adjustment values held in the storage unit 240 than in the case of the above range 10 to 30. Therefore, for example, a value of 1.2 (a value obtained by subtracting 20% of “1.5” from “1.5”) to 2.4 (a value obtained by adding 20% of “2.0” to “2.0”) as a recommended control value may be displayed on the single adjustment information input unit 312a.

The operation screen 310 illustrated in FIG. 5 is configured such that the possible range of the adjustment value in the quality information is set by the target value and the allowable range value. In addition, the operation screen 310 is configured such that the possible range of the control value in the adjustment information is set by the minimum value and the maximum value. The configuration of these input fields is merely an example, and the configuration is not limited to the illustrated configuration. An input field for setting the minimum value and the maximum value as a possible range of the adjustment value in the quality information may be used, or an input field for setting the target value and the allowable range value as a possible range of the control value in the adjustment information may be used. Further, the configuration of the input fields in the single quality information input unit 311a and the single adjustment information input unit 312a may be switched by a user's selection.

### Configuration Example of Data File of Adjustment Conditions

The adjustment conditions (quality information and adjustment information) input using the operation screen 310 as described above are received by the reception unit 260 of the data processing device 200, and the data file of adjustment conditions is created by the adjustment condition setting unit 230.

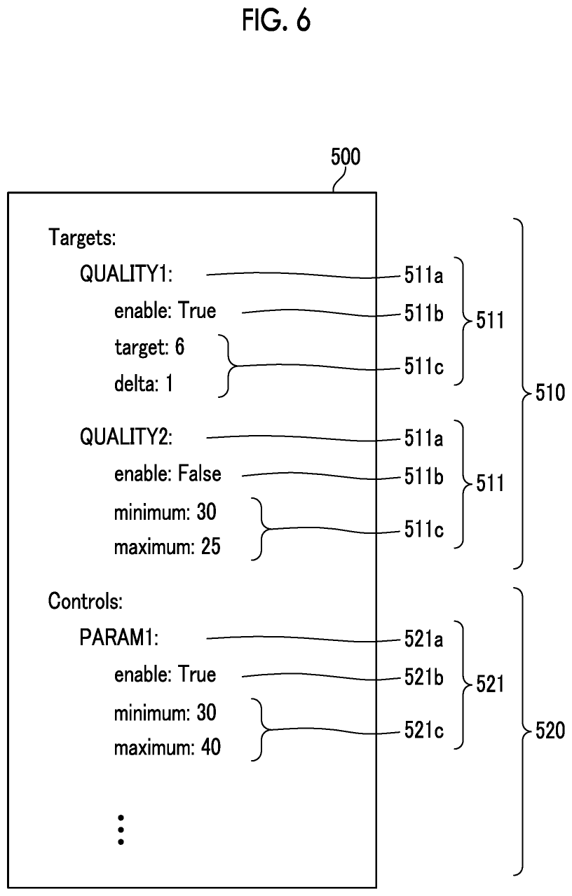

FIG. 6 is a diagram illustrating an example of a data file of adjustment conditions. FIG. 6 illustrates an example of a data file 500 of adjustment conditions created as a YAML file. The data file 500 illustrated in FIG. 6 includes a description portion of quality information 510 described as “Targets:” and a description portion of adjustment information 520 described as “Controls:”. The quality information 510 is created by the quality information setting unit 231 of the adjustment condition setting unit 230. The adjustment information 520 is created by the adjustment information setting unit 232 of the adjustment condition setting unit 230.

A quality information recording unit 511 for each quality item is described in the quality information 510. Each quality information recording unit 511 corresponds to the single quality information input unit 311a of the operation screen 310 illustrated in FIG. 5. In the example illustrated in FIG. 6, two quality information recording units 511 described as “QUALITY1:” and “QUALITY2:” are described. In the quality information recording unit 511, “QUALITY1:” and “QUALITY2:” are quality item specifying units 511a that specify quality items. Although not illustrated, the descriptions of “QUALITY1:” and “QUALITY2:” are associated with the identification information and the item name of the quality item input on the operation screen 310.

In the quality information recording unit 511, the portion described as “enable:” is valid setting information 511b. In the valid setting information 511b, setting information as to whether or not to validate the quality information input to the single quality information input unit 311a in response to the check of the check box 311b on the operation screen 310 is recorded. In the illustrated example, the quality information of “QUALITY1:” is set to valid (denoted as “True” in the drawing), and the quality information of “QUALITY2:” is set to invalid (denoted as “False” in the drawing).

In the quality information recording unit 511, the portions described as “target” and “delta” and the portions described as “minimum” and “maximum” are adjustment value information 511c. In the adjustment value information 511c, the information input to the input field for the possible range of the adjustment value on the operation screen 310 is recorded. In the illustrated example, in the quality information recording unit 511 of “QUALITY1:”, a target value “6” is set for “target” and an allowable range value “1” is set for “delta”. Further, in the quality information recording unit 511 of “QUALITY2:”, a minimum value “30” is set for “minimum” and a maximum value “25” is set for “maximum”.

An adjustment information recording unit 521 for each adjustment item is described in the adjustment information 520. Each adjustment information recording unit 521 corresponds to the single adjustment information input unit 312a of the operation screen 310 illustrated in FIG. 5. In the example illustrated in FIG. 6, one adjustment information recording unit 521 described as “PARAM1:” is described. In the adjustment information recording unit 521, “PARAM1:” is an adjustment item specifying unit 521a that specifies the adjustment item. Although not illustrated, the description of “PARAM1:” is associated with the identification information and the item name of the adjustment item input on the operation screen 310.

In the adjustment information recording unit 521, the portion described as “enable:” is valid setting information 521b. In the valid setting information 521b, setting information as to whether or not to validate the adjustment information input to the single adjustment information input unit 312a in response to the check of the check box 312b on the operation screen 310 is recorded. In the illustrated example, the adjustment information of “PARAM1:” is set to valid (denoted as “True” in the drawing).

In the adjustment information recording unit 521, the portions described as “minimum” and “maximum” are adjustment value information 521c. In the adjustment value information 521c, the information input to the input field for the possible range of the adjustment value on the operation screen 310 is recorded. In the illustrated example, in the adjustment information recording unit 521 of “PARAM1:”, a minimum value “30” is set for “minimum” and a maximum value “40” is set for “maximum”.

### Monitoring of Adjustment of Molding Conditions

Next, an operation of monitoring the adjustment of molding conditions via the monitoring unit 130 of the control device 100 will be described. In the manufacturing process during mass production of molding products by the injection molding machine 10, the molding conditions used in control by the control unit 110 of the control device 100 are adjusted by the molding condition adjusting unit 120 as necessary. Then, the monitoring unit 130 monitors the content of adjustment of molding conditions by the molding condition adjusting unit 120.

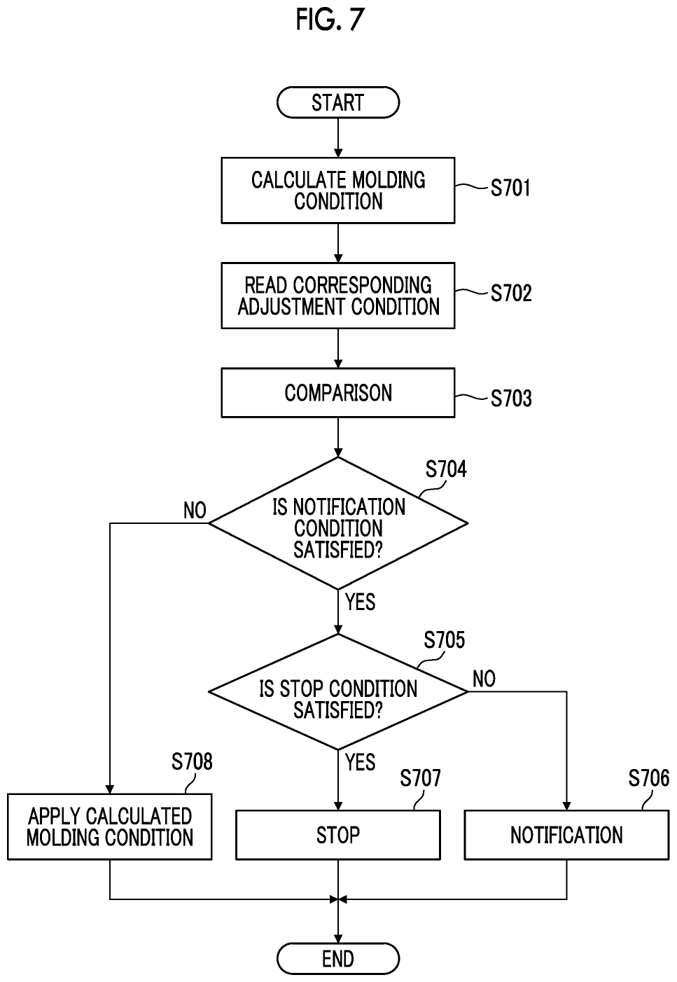

FIG. 7 is a flowchart illustrating an operation of monitoring adjustment of molding conditions by the monitoring unit 130. When the molding condition adjusting unit 120 calculates the molding condition as the adjustment content (S701), the monitoring unit 130 reads the adjustment condition 142 corresponding to the calculated molding condition from the storage unit 140 (S702). Then, the monitoring unit 130 compares the read adjustment condition 142 with the molding condition calculated by the molding condition adjusting unit 120 in S701 (S703), and determines whether or not the calculated molding condition satisfies a notification condition and a stop condition (S704 and S705).

Here, for example, the notification condition can be set based on a threshold set with respect to a possible range of the adjustment value or of the control value under the adjustment condition 142. The monitoring unit 130 determines that the notification condition is satisfied when the molding condition calculated in S701 exceeds the threshold. Specifically, for example, it is assumed that the adjustment condition 142 is the quality information shown in the quality information recording unit 511 of “QUALITY1:” illustrated in FIG. 6, and the threshold is set to “0.8” with respect to the allowable range value “1”. In this case, when the molding condition calculated in S701 is to adjust the molding condition corresponding to the quality information of “QUALITY1:” to a value larger than 6.8(=6+0.8) or a value smaller than 5.2(=6−0.8), the monitoring unit 130 determines that the molding condition satisfies the notification condition in S704 of FIG. 7.

Further, it is assumed that the adjustment condition 142 is the adjustment information shown in the adjustment information recording unit 521 of “PARAM1:” illustrated in FIG. 6, and the threshold is set to “32” with respect to the minimum value “30”, and the threshold is set to “38” with respect to the maximum value “40”. In this case, when the molding condition calculated in S701 is to adjust the molding condition corresponding to the adjustment information of “PARAM1:” to a value smaller than 32 or a value larger than 38, the monitoring unit 130 determines that the molding condition satisfies the notification condition in S704 of FIG. 7.

Furthermore, for example, the stop condition can be set based on a possible range of the adjustment value or of the control value under the adjustment condition 142. When it is determined that, if an adjustment is made according to the molding condition (refer to S701) calculated by the molding condition adjusting unit 120, the adjustment cannot be made within the possible range of the adjustment value or of the control value under the adjustment condition 142, the monitoring unit 130 determines that the stop condition is satisfied. In addition, even when an adjustment cannot be made within the possible range of the adjustment value or of the control value under the adjustment condition 142 in the adjustment based on the molding condition calculated in S701, the monitoring unit 130 may not determine that the stop condition is satisfied in some cases. For example, depending on the type of the molding condition as an adjustment target, even though the molding condition is adjusted beyond the possible range of the adjustment value or of the control value under the adjustment condition 142, no problem may occur immediately. In such a case, the monitoring unit 130 may wait until the adjustment value or the control value under the adjustment condition 142 falls within the possible range after the adjustment by the molding condition adjusting unit 120 is performed one or more times without determining that the stop condition is satisfied immediately. Further, in this case, the monitoring unit 130 may determine that the stop condition is satisfied when the molding condition calculated in S701 does not fall within the possible range of the adjustment value or of the control value under the adjustment condition 142 even after the adjustment by the molding condition adjusting unit 120 is performed a predetermined number of times.

Referring back to the flowchart of FIG. 7, when the molding condition calculated by the molding condition adjusting unit 120 in S701 does not satisfy the notification condition (NO in S704), the calculated molding condition is within the possible range of the adjustment value or of the control value, which is the adjustment condition. Therefore, in the molding condition adjusting unit 120, the molding condition calculated in S701 is applied to the control unit 110 (S708), and the control unit 110 implements the control of the injection unit 20 and the mold clamping unit 30 by the control unit 110 based on the molding condition.

When the molding condition calculated by the molding condition adjusting unit 120 in S701 satisfies the notification condition (YES in S704) and does not satisfy the stop condition (NO in S705), the calculated molding condition is within the possible range of the adjustment value or of the control value, which is the adjustment condition, but the value is close to the boundary of this range. Therefore, the monitoring unit 130 notifies the user that the molding condition is close to the boundary of the possible range of the adjustment value or of the control value (S706).

Further, when the molding condition calculated by the molding condition adjusting unit 120 in S701 satisfies the stop condition (YES in S705), the calculated molding condition exceeds the possible range of the adjustment value or of the control value, which is the adjustment condition. Therefore, if an adjustment is made according to the calculated molding condition (refer to S701), the adjustment cannot be made within the possible range of the adjustment value or of the control value under the adjustment condition 142. Thus, the monitoring unit 130 causes the control unit 110 to stop the operations of the injection unit 20 and the mold clamping unit 30 (S707).

Depending on the model of the machine learning or other mathematical optimization method used in the molding condition adjusting unit 120 of the control device 100, excessive adjustment of the molding condition may result in deterioration of the quality of the molding product. As described above, the adjustment condition set by the adjustment condition setting unit 230 of the data processing device 200 is used, and the monitoring unit 130 controls the adjustment condition based on the adjustment condition, whereby excessive adjustment of the molding condition by the molding condition adjusting unit 120 can be suppressed.

In addition, using the adjustment condition set by the adjustment condition setting unit 230 of the data processing device 200, adjustment of the molding condition by the molding condition adjusting unit 120 of the control device 100 and control of the operations of the injection unit 20 and the mold clamping unit 30 by the control unit 110 can be performed. For example, in the adjustment of the molding condition by the molding condition adjusting unit 120, the adjustment range of the molding condition which can be changed by one adjustment may be limited based on the adjustment condition set by the adjustment condition setting unit 230. Specifically, one adjustment range can be limited to 1/n times or the like the allowable range set in the adjustment condition.

Further, when machine learning is used as the molding condition adjusting unit 120, the adjustment condition set by the adjustment condition setting unit 230 can be used in data preprocessing for aligning input/output scales. For example, it is assumed that a lower limit value is set to li and an upper limit value is set to mi as a possible range of the adjustment value for the i-th quality item by the quality information setting unit 231 of the adjustment condition setting unit 230. As the data handled by the machine learning model, which is an objective function when performing optimization, a value subjected to a conversion such as in the following Equation 1 is used.

$$\tilde{{y}_{i}} = \frac{2 ( {y}_{i} - \overline{{y}_{i}} )}{{m}_{i} - {l}_{i}} \\ where \overline{{y}_{i}} = \frac{{l}_{i} + {m}_{i}}{2} \qquad [ Equation 1 ]$$

In the above Equation 1, yi is a current value (hereinafter referred to as a “molding quality value”) of information related to the quality of the molding product of interest.

Similar processing is performed for the molding conditions by using the information on the lower limit value and upper limit value of the possible range of the adjustment values for the quality items by the adjustment information setting unit 232 (single adjustment information setting unit 232a). Many machine learning models require preprocessing to align the scale of input/output to be handled. When the above-illustrated processing is performed as the preprocessing, the conversion can be performed such that the scale of input/output to be handled falls within a range of approximately ±1.

Moreover, in order to select a set of molding conditions as an objective function when performing optimization, the adjustment conditions set by the adjustment condition setting unit 230 can be used. For example, it is assumed that N types of pieces of quality information are set by the quality information setting unit 231 of the adjustment condition setting unit 230 and that the lower limit value is set to li and the upper limit value is set to mi as a possible range of the adjustment value for the i-th quality item. As the objective function when performing the optimization, a set x of adjustment information that minimizes L in the following Equation 2 is selected.

$$L = {{\sum }_{i}}^{N} \frac{\hat{{y}_{i}} ( x ) - \overline{{y}_{i}}}{{m}_{i} - {l}_{i}} \qquad [ Equation 2 ]$$

where ŷᵢ(x) is the quality of the molding product predicted when given the set x of molding conditions.

By selecting the set of molding conditions in this way, it is possible to set the priority when performing adjustments for each quality item.

### Other Display Example of Operation Screen 310

An example has been described in which the adjustment condition setting unit 230 of the data processing device 200 sets adjustment conditions for quality information and adjustment information. However, a more detailed adjustment condition (hereinafter, this adjustment condition is referred to as a “detailed adjustment condition”) regarding the control of the injection unit 20 and the mold clamping unit 30 by the control unit 110 may be set. For example, the setting target includes a condition for changing the adjustment method itself by the molding condition adjusting unit 120, and the like. Specifically, selection of an algorithm used by the molding condition adjusting unit 120 to adjust the control condition, a feedback gain when feeding back acquired data obtained by the data acquisition unit 210 of the data processing device 200 to the molding condition adjusting unit 120 of the control device 100, an optimization termination condition for adjustment of the control condition by the molding condition adjusting unit 120, and the like are included.

Since the setting of the detailed adjustment condition has a large influence on the control by the control unit 110, the setting is performed by a setting method distinguishable from the setting of quality information and adjustment information. Specifically, for example, on the operation screen 310 (refer to FIG. 5), the quality information and the adjustment information and the detailed adjustment information may be visually distinguished by different display modes, such as by displaying them in different background colors. Further, the detailed adjustment information may be set using an operation screen different from the operation screen 310 for setting the quality information and the adjustment information. When an operation screen different from the operation screen 310 is used to set the detailed adjustment information, the display control unit 250 of the data processing device 200 may perform control such that the operation screen for setting the detailed adjustment information is not displayed depending on the operation of a general user by means such as setting user authentication as a display condition for the operation screen for setting the detailed adjustment information.

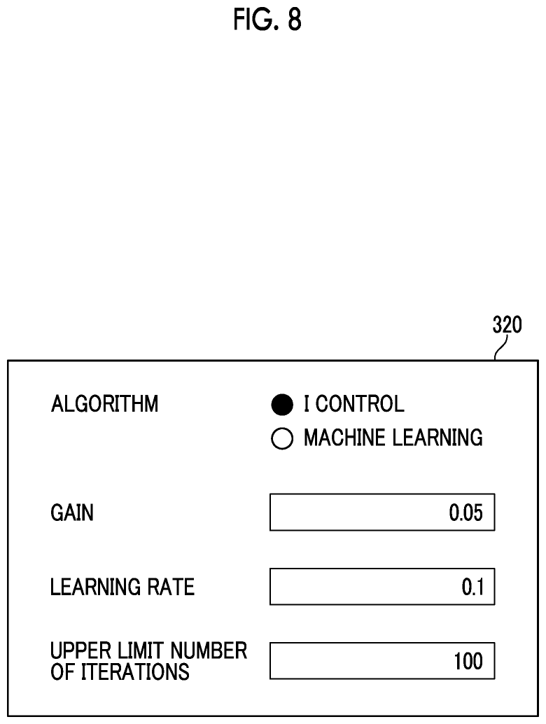

FIG. 8 is a diagram illustrating a configuration example of an operation screen for setting detailed adjustment information. When the display control unit 250 of the data processing device 200 receives the input of the detailed adjustment information, the display control unit 250 generates an operation screen 320 as illustrated in FIG. 8, and displays the operation screen 320 on the display unit 300. The operation screen 320 illustrated in FIG. 8 is provided with an “algorithm”, a “gain”, a “learning rate”, and an “upper limit number of iterations” as input items. The “algorithm” is an item for selecting an algorithm used by the molding condition adjusting unit 120 for adjusting the control condition, and in the illustrated example, radio buttons are configured such that two types of algorithms, “I control” (integral control) and machine learning, can be selected. The “gain” is an item for setting a feedback gain when feeding back acquired data of the data processing device 200 in the machine learning used in the molding condition adjusting unit 120 of the control device 100. The “learning rate” is an item for setting a learning rate in machine learning used in the molding condition adjusting unit 120 of the control device 100. The “upper limit number of iterations” is an item for setting an upper limit of the number of iterations of learning data in learning of machine learning used in the molding condition adjusting unit 120 of the control device 100. Note that the operation screen 320 illustrated in FIG. 8 is merely an example of an operation screen for setting the detailed adjustment information, and the means for setting the detailed adjustment information is not limited to the operation screen 320 illustrated in FIG. 8.

Although the embodiment of the present invention has been described above, the technical scope of the present invention is not limited to the above-described embodiment. For example, in the above-described embodiment, the operation screen 310 is provided with the quality information input unit 311 and the adjustment information input unit 312, but in addition to this, the operation screen 310 may display information, such as the mold name of the mold corresponding to the molding product to be manufactured, current molding conditions, and logging values, that will serve as a reference when the user determines adjustment items to be input to the adjustment information input unit 312.

Further, in the above-described embodiment, the injection molding machine 10 has been described as having a configuration including the control device 100, the data processing device 200, and the display unit 300. However, the present invention is not limited to such a configuration. For example, a display of an external device connected to the data processing device 200 may be used as the display unit 300, and the operation screens 310 and 320 may be displayed on the display. Further, the function of the display control unit 250 of the data processing device 200 and the function of the display unit 300 may be implemented by an information processing device such as a personal computer, a smartphone, and a tablet terminal, and the information processing device may acquire data such as acquired data from the data processing device 200 and display the operation screens 310 and 320. In this case, the operation screens 310 and 320 may be created as web content and displayed on the information processing device via a web browser.

Further, the data processing device 200 and the display unit 300 may be implemented by an information processing device such as a personal computer, and actual values from the injection unit 20 and the mold clamping unit 30 and information such as adjustment conditions received by displaying the operation screens 310 and 320 on the display of the information processing device may be transmitted to the control device 100. Similarly, the control device 100 may be implemented by an information processing device such as a personal computer, and information such as acquired data and adjustment conditions may be received from the data processing device 200 to control the injection unit 20 and the mold clamping unit 30.

Further, the functions of the molding condition adjusting unit 120 and the monitoring unit 130 of the control device 100 are implemented by an information processing device such as a personal computer, and information such as acquired data and adjustment conditions may be acquired from the data processing device 200, the molding conditions used in control by the control unit 110 of the control device 100 may be adjusted, and the adjustment of the molding conditions may be monitored so as not to exceed the adjustment conditions set by the data processing device 200. In addition, various modifications and alternative configurations that do not depart from the scope of the technical idea of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing device that receives an operation of setting an adjustment condition for an automatic adjustment function in an injection molding machine capable of automatically adjusting a molding condition, the information processing device comprising:
a first input reception unit that receives an input of a quality item related to maintaining a quality of a molding product as the setting of the adjustment condition; and
a second input reception unit that receives an input of an adjustment item as an adjustment target for maintaining the quality of the molding product as the setting of the adjustment condition.

2. The information processing device according to claim 1, wherein the first input reception unit receives an input of identification information of the quality item and an input of a possible range of an adjustment value for the quality item.

3. The information processing device according to claim 2, wherein the first input reception unit receives a designation of a target value and an allowable range with respect to the target value in the input of the possible range of the adjustment value.

4. The information processing device according to claim 1, wherein the second input reception unit receives an input of identification information of the adjustment item and an input of a possible range of a control value for the adjustment item.

5. The information processing device according to claim 4, wherein the second input reception unit receives a designation of a minimum value and a maximum value allowed as the control value in the input of the possible range of the control value.

6. The information processing device according to claim 1, further comprising:
a display control unit that causes a display unit to display an operation screen including at least one of a first input unit for performing an input to the first input reception unit and a second input unit for performing an input to the second input reception unit.

7. The information processing device according to claim 6, wherein the operation screen includes both the first input unit and the second input unit, and displays, when an input is made on the first input unit, the adjustment item related to the input quality item on the second input unit.

8. The information processing device according to claim 7, wherein the operation screen displays a reference value of a possible range of a control value specified based on an actual molding result in the adjustment item of the second input unit displayed according to the input on the first input unit.

9. The information processing device according to claim 6, wherein the operation screen includes a valid setting unit for setting whether or not to perform adjustment based on an input value and an input range in the automatic adjustment function of the injection molding machine for each input item.

10. The information processing device according to claim 6, wherein the operation screen includes an input fixing unit having an input value and an input range as fixed values for each input item.

11. An injection molding machine comprising:
an injection unit;
a mold clamping unit;
a control device that has an automatic adjustment function of a molding condition and that controls the injection unit and the mold clamping unit; and
a processing device that receives an operation of setting an adjustment condition for the automatic adjustment function, wherein
the control device automatically adjusts the molding condition in accordance with a setting of the adjustment condition received by the processing device, and
the processing device includes
a first input reception unit that receives an input of a quality item related to maintaining a quality of a molding product as the setting of the adjustment condition, and
a second input reception unit that receives an input of an adjustment item as an adjustment target for maintaining the quality of the molding product as the setting of the adjustment condition.

12. The injection molding machine according to claim 11, wherein the control device includes a notification unit that notifies a user when content of the adjustment by the automatic adjustment function satisfies a notification condition predetermined for the setting of the adjustment condition received by the processing device.

13. The injection molding machine according to claim 11, wherein the control device stops operations of the injection unit and the mold clamping unit when content of the adjustment by the automatic adjustment function satisfies a stop condition predetermined for the setting of the adjustment condition received by the processing device.

14. The injection molding machine according to claim 11, further comprising:
a display unit that displays an operation screen including at least one of a first input unit for performing an input to the first input reception unit of the processing device and a second input unit for performing an input to the second input reception unit of the processing device.

15. A non-transitory computer readable medium storing a program that causes a computer to function as:
a first input reception unit that receives an input of a quality item related to maintaining a quality of a molding product;
a second input reception unit that receives an input of an adjustment item as an adjustment target for maintaining the quality of the molding product; and
a transmission unit that transmits, to a control device capable of automatically adjusting a molding condition, information on setting including at least one of the quality item and the adjustment item, the setting being setting of an adjustment condition for an automatic adjustment function in an injection molding machine including the control device.
